(19) United States
(12) Patent Application Publication
(10) Pub. No.: US 2018/0169806 A1
(43) Pub. Date: Jun. 21, 2018

(54) CASTLE NUT/COTTER PIN ALIGNMENT ELECTRIC TOOLING

(71) Applicant: Toyota Motor Engineering & Manufacturing North America, Inc., Erlanger, KY (US)

(72) Inventors: Jeffery James Dorie, Belwood (CA); Slavko Saric, Kitchener (CA)

(21) Appl. No.: 15/381,975

(22) Filed: Dec. 16, 2016

(51) Int. Cl. B23P 19/06; B23P 19/10; B25B 21/00

(52) U.S. Cl. CPC B23P 19/065; B25B 21/00; B23P 19/105

(57) ABSTRACT

Described herein is a system comprising a controller and a tool for tightening a fastener. The controller may comprise a memory and processor. The processor may be configured to transmit a first command comprising a torque value to the tool; receive a rotational angle of the fastener after the fastener is tightened to the torque value; determine an additional rotation based, at least in part, on the rotational angle; and transmit a second command to the tool comprising the additional rotation. The tool may comprise a rotary encoder, a controller interface, and a tool head. The rotary encoder may be configured to determine the rotational angle of the fastener. The controller interface may be configured to receive the first command and the second command from the controller. The tool head may be configured to tighten the fastener based, at least in part, upon the first command and the second command.

### TECHNICAL FIELD

The subject matter described herein relates in general to fastening devices, and more particularly, to programmable fastening tools.

### BACKGROUND

Some manufacturing requires repeated tightening of fasteners. Fastening tools, e.g., a nutrunner, are programmed for repeated tightening of a particular type of fastener. The programmable tools execute a program for tightening a fastener. Many different types of fasteners are available for fastening. Some fasteners have a hole or other type of notch or slot to insert a cotter pin through. The notch or slot on the fastener lines up with a hole or opening in a bolt or other axle that the fastener is installed on. These types of fasteners are referred to as, for example, a castellated nut, castle nut, or slotted nut. These terms may be used interchangeably herein and are meant to encompass any type of fastener through which a cotter pin or other locking mechanism, e.g., safety wire or an r-clip, may be installed. Additionally, as used herein a cotter pin may be exchanged for any type of device used for securing the castle nut in place, e.g., safety wire, r-clip, split pin, etc.

### SUMMARY

In an embodiment herein, a tool is described. The tool may comprise a rotary encoder configured to determine a rotational angle of a fastener; a controller interface configured to: receive a first command comprising a torque value; transmit the rotational angle of the fastener after the fastener is tightened to the torque value; and receive a second command comprising an additional rotation. The tool may comprise a tool head configured to: tighten the fastener to a first position based, at least in part, on the first command; and tighten the fastener to a second position based, at least in part, on the second command.

In another embodiment described herein, a system for tightening a fastener is described. The system may comprise a controller and a tool. The controller may comprise a memory and a processor coupled to the memory. The processor may be configured to: transmit a first command to a tool, the first command comprising a torque value; receive a rotational angle of the fastener after the fastener is tightened to the torque value; determine an additional rotation based, at least in part, on the rotational angle; and transmit a second command to the tool comprising the additional rotation. The tool may comprise a rotary encoder configured to determine the rotational angle of the fastener; a controller interface to receive the first command and the second command from the controller; and a tool head configured to tighten the fastener based, at least in part, upon the first command and the second command.

In another embodiment described herein, a method for tightening a fastener is described. The method may comprise: transmitting, from a controller to a tool, a first command comprising a torque value; receiving, by the controller, a rotational angle of the fastener after the fastener is tightened to the torque value; determining, by the controller, an additional rotation based, at least in part, on the rotational angle; and transmitting, from the controller to the tool, a second command comprising the additional rotation.

### BRIEF DESCRIPTION OF THE DRAWINGS

FIG. 1 is a diagram of an embodiment of a system for castle nut alignment.

FIG. 2A is a diagram of an embodiment of a nutrunner tightening a castle nut.

FIG. 2B is a diagram of an embodiment of a castle nut.

FIG. 2C is a diagram of an embodiment of components of a castle nut assembly.

FIG. 2D is a diagram of an embodiment of an assembled castle nut assembly.

FIG. 3 is flow diagram of an embodiment of a method for tightening a castle nut.

FIG. 4 is flow diagram of an embodiment of a method for tightening a castle nut.

FIG. 5 is a diagram of a system for controlling castle nut alignment.

### DETAILED DESCRIPTION

Described herein is a system and method for castle nut cotter pin alignment. In an embodiment, a tool may be fitted with a device for measuring the rotation of a tool head attached to the tool, e.g., a rotary encoder. The tool may be a nutrunner or any programmable and/or remotely controllable tool for rotationally tightening a fastener. The tool head may be a socket or some other fixture for tightening a fastener. The fastener may be a castle nut, other slotted fastener, or some other fastener that may be secured after tightening. The fastener may need to be tightened to a specific torque. When the fastener is tightened to the torque, the slots or holes on the fastener may not align with the pin hole on the bolt or threaded rod where the fastener is attached. A rotary encoder may measure the current rotational angle of the fastener and may transmit that value to a controller. The controller may be configured to control the operation of the tool, e.g., cause the tool head to rotate and tighten the fastener to the predetermined torque. In an embodiment, after reaching the predetermined torque, the controller may determine the amount of rotation required in order to align the slot with the pin hole based on a measurement from the rotary encoder. After determining the amount of rotation, the controller may cause the tool head to rotate the determined amount of rotation. In another embodiment, after reaching the predetermined torque, the controller may monitor an output of the rotary encoder. The tool may continue tightening after reaching the predetermined torque. The rotary encoder may output a signal at each multiple of sixty degrees. When the controller receives the signal from the rotary encoder, the controller may cause the tool to stop tightening. Subsequently, a cotter pin or other securing device may be inserted through an opening on the fastener and the pin hole on the rod or bolt where the fastener is installed. The controller may be separate from the tool or may be a component of the tool.

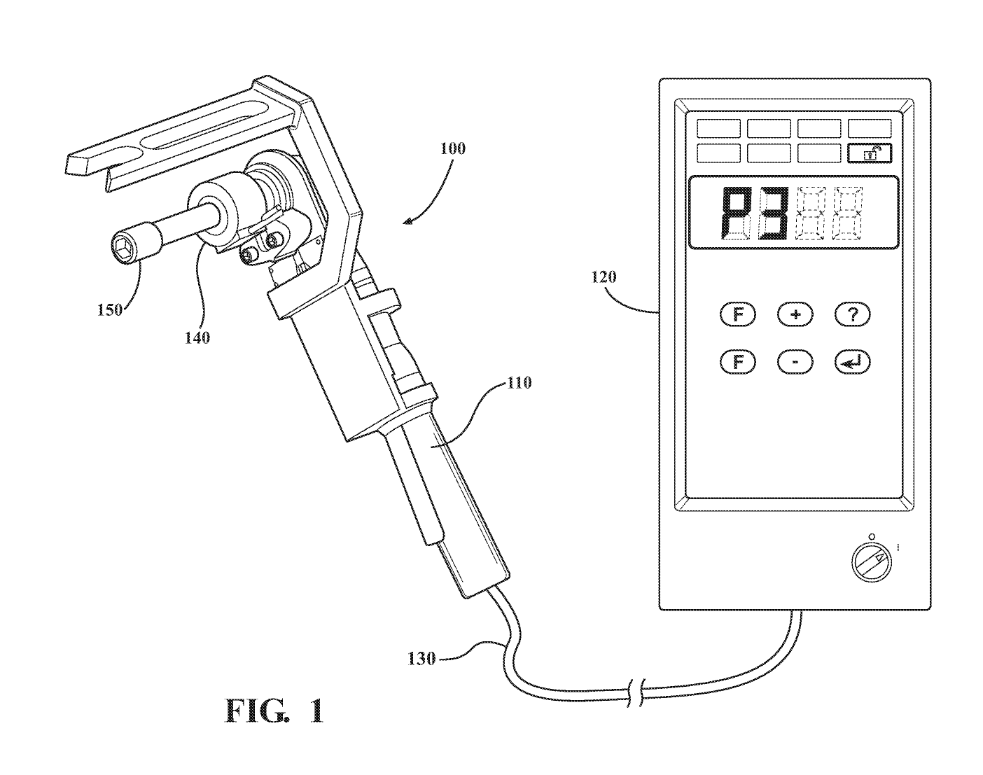

FIG. 1 is a diagram of a system 100 for castle nut tightening and alignment. The system 100 may comprise a nutrunner 110 and a controller 120. The nutrunner 110 may be a pneumatic, electric, or hydraulic driven tool for tightening a nut. In some embodiments, the nutrunner 110 may be replaced with some other programmable tool that is remotely controlled for tightening a fastener. Nutrunner 110 may be a cylindrical nutrunner, or a pistol grip type nutrunner or any other configuration of nutrunner. In some embodiments, the nutrunner 110 may be used on an automotive assembly line or in some other tightening or assembly application. The nutrunner 110 may be attached to an assist arm and balancer (not pictured). The assist arm and balancer may reduce the amount of weight an operator of the nutrunner is required to support. The assist arm and balancer may allow for additional flexibility while using the nutrunner.

Controller 120 may be selected to be compatible with nutrunner 110. Controller 120 may be selected to provide a consistent torque to each fastener tightened by nutrunner 110. Based on the nutrunner 110, the controller 120 may be an electrical controller, a pneumatic controller, or a hydraulic controller. Controller 120 may include manual controls such as potentiometers, dials, and switches. Displays on controller 120 may be needle-based meters, light emitting diode (LED) indicators, or some other indicator device. In some embodiments, users may setup or program controller 120 with a digital keypad or menu on a graphical user interface and an internal central processing unit (CPU) or programmable logic controller (PLC). In some embodiments, controller 120 may interface with a computing device via a serial or parallel interface along with application software for control and monitoring. Serial interfaces may include RS232, RS485 and universal serial bus (USB). Parallel interfaces may include the general-purpose interface bus (GPIB), Hewlett Packard Interface Bus (HPIB). GPIB may also be referred to as the IEEE 488 bus, which may be electrically equivalent to the IEC 625 bus. Controller 120 may be configured to drive multiple nutrunners. Controller 120 may be further configured to include soft starting, automatic shutoff, and remote control. Soft starting may increase torque gradually in order to minimize cross-threading. Automatic shutoff may be activated when a torque or angle limit is achieved. The nutrunner 110 and controller 120 may communicate via a cable 130. Cable 130 may connect to an interface on the controller and an interface on the nutrunner. In other embodiments, the nutrunner may communicate wirelessly with controller 100. In still other embodiments, the nutrunner 110 may contain the controller 120.

Nutrunner 110 may comprise a rotary encoder 140 and a tool head 150. Rotary encoder 140 may be configured to determine the rotational angle of tool head 150. The rotary encoder 140 may be implemented using any technology for measuring rotational angle. The rotary encoder 140 may use conductive technology, optical technology, on-axis magnetic technology, or off-axis technology for measuring rotational angle of the tool head 150. Other technologies may be used by the rotary encoder 140 to measure the rotational angle of the tool head 150. Rotary encoder 140 may be an absolute encoder or an incremental (relative) encoder. In other embodiments, some other device that measures rotational angle of the tool head 150 may be used. Rotary encoder 140 may be in communication with controller 120. In an embodiment, a measured rotational angle may be provided to the controller 120 from rotary encoder 140. In an embodiment, the rotary encoder 140 may output a signal to the controller 120 each time the angle of rotation is a multiple of a predetermined degree measurement.

Tool head 150 may be a socket or crowfoot or any other fixture for tightening a fastener, e.g., a castle nut. Tool head 150 may accept sockets of varying sizes and types. In-line heads may rotate concentrically with the drive of nutrunner 110. Offset heads may rotate parallel to but offset from the drive axis of nutrunner 110. Right-angle heads may rotate 90° to the drive axis of nutrunner 110. Crowfoot heads may be flat, extended and/or angled heads for difficult-to-access locations. Tubenut heads may have openings for slipping over a nut before and after tightening.

Controller 120 may store a number of tightening programs. Depending on the fastener being tightened by nutrunner 110, one of the tightening programs may be selected. The tightening programs may store information related to tightening the fastener, for example torque, angle of rotation, speed of rundown, and other information that may be used for identifying and/or tightening a fastener. The tightening programs may also store information related to rotational angles at which a pin may be inserted through a castle nut and a bolt onto which the castle nut is installed.

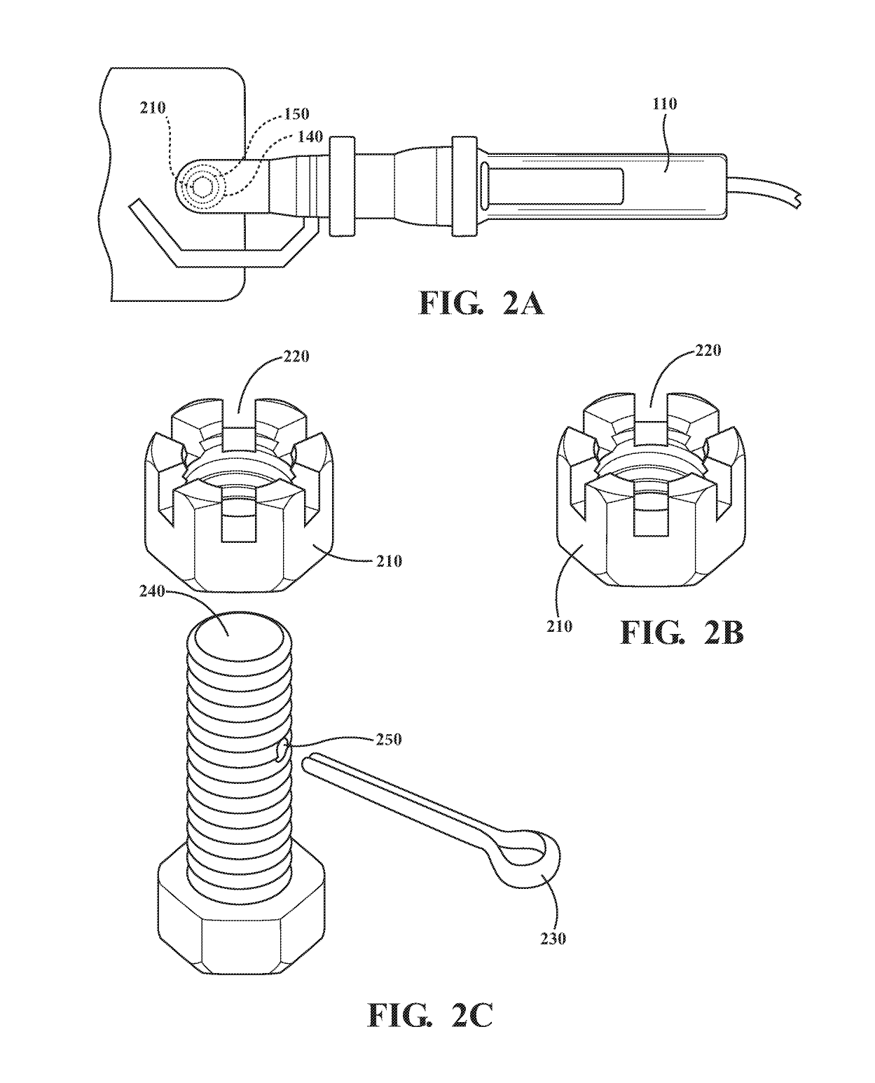

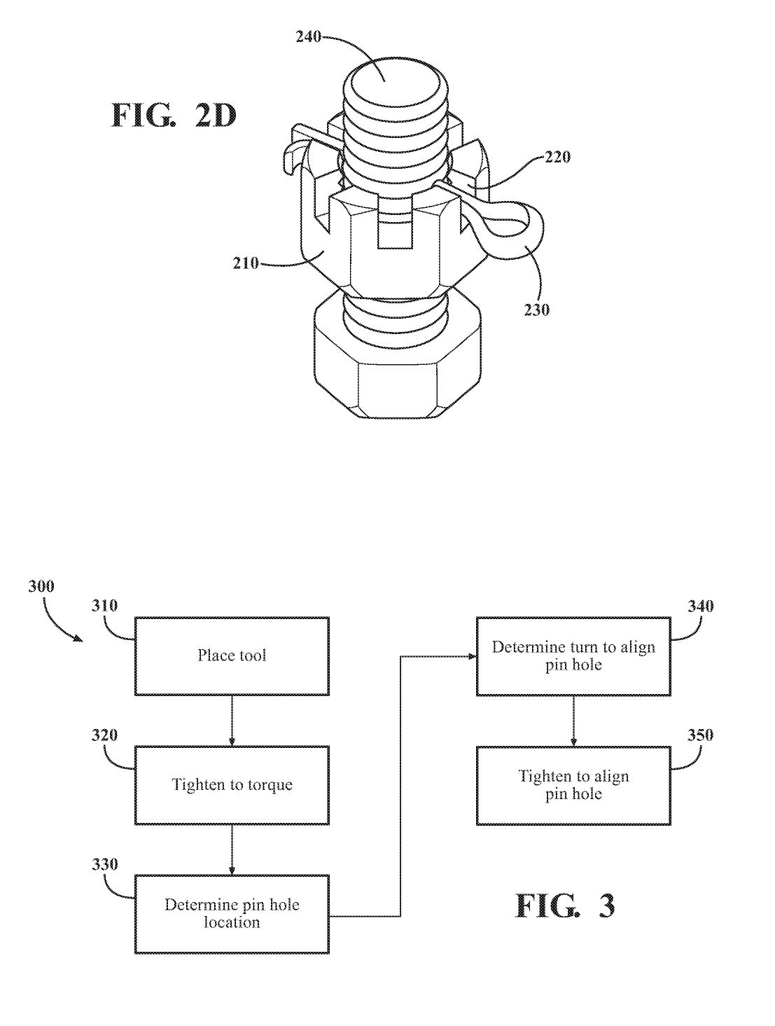

FIG. 2A is a diagram of an embodiment of a nutrunner tightening a castle nut. Nutrunner 110 may be positioned over a castle nut 210. Tool head 150 may be a socket sized to fit castle nut 210. As tool head 150 is rotated, rotary encoder 140 may measure the angle of rotation of tool head 150. A controller, e.g., controller 120, may control the tightening process. FIG. 2B is diagram of an embodiment of a castle nut 210. The castle nut 210 may be hexagonal and threaded. Various sizes, shapes, and thread types may be used for castle nut 210 depending on the application. Castle nut 210 may comprise several slots 220. The slots 220 may be used for inserting a pin or other device through a bolt for securing castle nut 210.

FIG. 2C is a diagram of an embodiment of components of a castle nut and bolt assembly. The assembly may comprise a castle nut 210, bolt 240, and cotter pin 230. The castle nut 210 may comprise one or more slots 220. The bolt 240 may comprise one or more pin holes 250. FIG. 2D is a diagram of an embodiment of an assembled castle nut and bolt assembly. Castle nut 210 may be tightened onto bolt 240 using, for example, nutrunner 110. Castle nut 210 may be tightened to a predetermined torque value. After the castle nut 210 is tightened to the predetermined torque value, the castle nut 210 may be tightened further to align slots 220 with pin hole 250. When slots 220 and pin hole 250 are aligned, cotter pin 230 may be inserted through slots 220 and pin hole 250. Cotter pin 230 may be secured after insertion. In other embodiments, other securing devices may be used in place of cotter pin 230. For example, safety wire, various clips, or other pins. In other embodiments, any threaded stem may be used in place of bolt 240. In some embodiments, more than one pin hole 250 may be present on bolt 240.

FIG. 3 is a flow diagram of an embodiment of a method 300 for tightening a castle nut. The method 300 begins at block 310 when a tool, e.g., nutrunner 110, is placed on a nut for tightening. The nut may be a castle nut, slotted nut, or any other nut that is subsequently secured by a pin, safety wire, or some other securing device. A controller, e.g., controller 120 may tighten the nut to a predetermined torque at step 320. The torque may be stored as part of a program within the controller. The torque may be measured using various techniques for determining torque.

At step 330, the controller may determine the angle of rotation of the nut after the predetermined torque is reached. The angle of rotation may be determined using a rotary encoder installed on the nutrunner. The rotary encoder may measure the angle of rotation while the nutrunner is tightening the nut to the predetermined torque. The angle of rotation may be measured relative to a point of origin on the nut or on the bolt that the nut is being tightened on. The angle of rotation may also be determined relative to a pin hole in the bolt.

At step 340, the controller may determine the amount of turn required to align slots in the nut with the pin hole in the bolt. In the case where the nut has six sides and slots, the desired angular rotation may be a multiple of 60, 360 degrees divided by six sides is 60 degrees. As an example, if the controller determines the nut is at a rotation angle of 42 degrees, the controller may further determine the nut should be rotated an additional 18 degrees in order to align the slots of the nut with the pin hole of the bolt. If the nut has less or more sides and/or slots, different desired angles of rotation may be used. For example, if the nut has two slots, the desired angle of rotation may a multiple of 180, 360 degrees divided by two slots is 180 degrees. The controller may subtract the measured rotational angle from some predetermined fraction of 360 degrees. The predetermined fraction may be based upon the number of sides of the fastener, the number of slots or openings on the fastener, the number of pin holes on the bolt or threaded rod, or any combination thereof.

At step 350, the controller controls the nutrunner to tighten the nut the determined rotation to align the pin hole and slots.

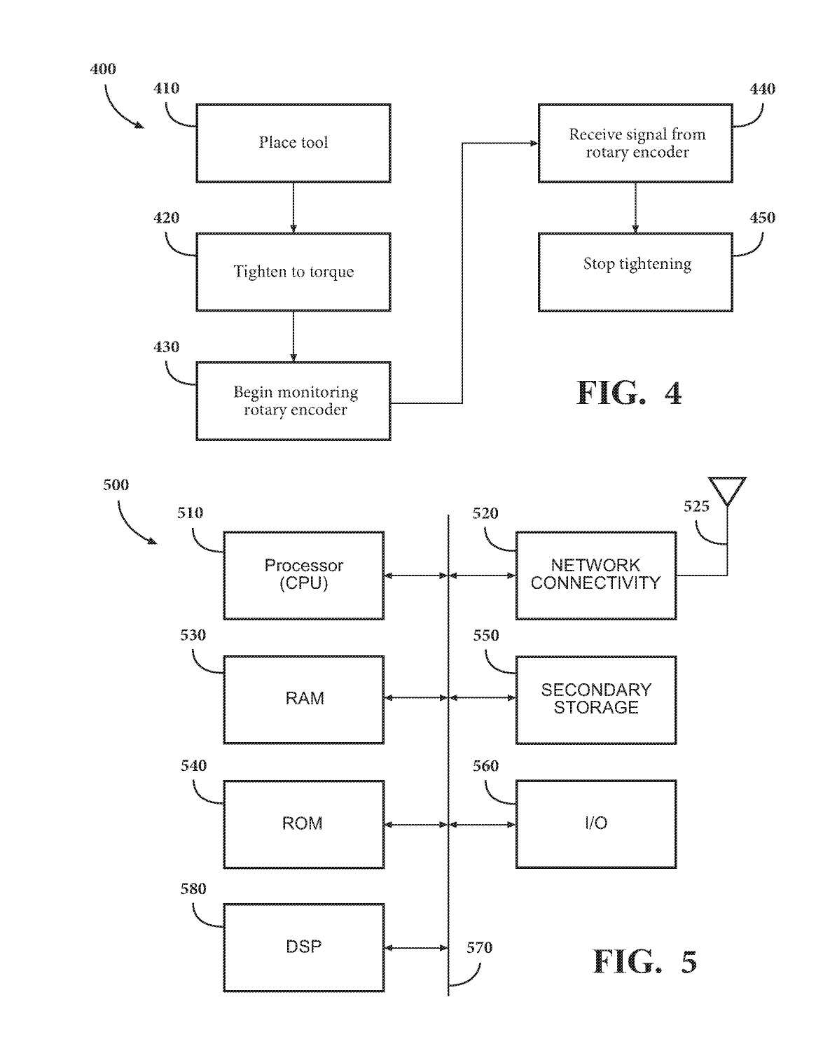

FIG. 4 is a flow diagram of an embodiment of a method 400 for tightening a castle nut. The method 400 begins at block 410 when a tool, e.g., nutrunner 110, is placed on a nut for tightening. The nut may be a castle nut, slotted nut, or any other nut that is subsequently secured by a pin, safety wire, or some other securing device. A controller, e.g., controller 120 may tighten the nut to a predetermined torque at step 420. The torque may be stored as part of a program within the controller. The torque may be measured using various techniques for determining torque.

After reaching the predetermined torque, the controller may begin monitoring the output of a rotary encoder coupled to the tool at block 430. The rotary encoder may be configured to output a signal each time the rotary encoder passes a degree measurement. For example, each time the rotary encoder passes a multiple of sixty degrees, the rotary encoder may output a signal. At step 440 the controller may receive the signal from the rotary encoder indicating the rotary encoder has reached the angle of rotation. The angle may be selected based upon the location of the slots in the nut being tightened. At step 450 the controller may signal the tool to stop tightening.

* FIG. 5 is a diagram of an embodiment of a system 500 that includes a processor 510 suitable for implementing one or more embodiments disclosed herein, e.g., a controller for controlling a tool. The processor 510 may control the overall operation of the system.

In addition to the processor 510 (which may be referred to as a central processor unit or CPU), the system 500 might include network connectivity devices 520, random access memory (RAM) 530, read only memory (ROM) 540, secondary storage 550, and input/output (I/O) devices 560. These components might communicate with one another via a bus 570. In some cases, some of these components may not be present or may be combined in various combinations with one another or with other components not shown. These components might be located in a single physical entity or in more than one physical entity. Any actions described herein as being taken by the processor 510 might be taken by the processor 510 alone or by the processor 510 in conjunction with one or more components shown or not shown in the drawing, such as a digital signal processor (DSP) 580. Although the DSP 580 is shown as a separate component, the DSP 580 might be incorporated into the processor 510.

The processor 510 executes instructions, codes, computer programs, or scripts that it might access from the network connectivity devices 520, RAM 530, ROM 540, or secondary storage 550 (which might include various disk-based systems such as hard disk, floppy disk, or optical disk). While only one CPU 510 is shown, multiple processors may be present. Thus, while instructions may be discussed as being executed by a processor, the instructions may be executed simultaneously, serially, or otherwise by one or multiple processors. The processor 510 may be implemented as one or more CPU chips and may be a hardware device capable of executing computer instructions.

The network connectivity devices 520 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, controller area network (CAN), domestic digital bus (D2B), and/or other well-known devices for connecting to networks. These network connectivity devices 520 may enable the processor 510 to communicate with the Internet or one or more telecommunications networks or other networks from which the processor 510 might receive information or to which the processor 510 might output information. The network connectivity devices 520 might also include one or more transceiver components 525 capable of transmitting and/or receiving data wirelessly.

The RAM 530 might be used to store volatile data and perhaps to store instructions that are executed by the processor 510. The ROM 540 is a non-volatile memory device that typically has a smaller memory capacity than the memory capacity of the secondary storage 550. ROM 540 might be used to store instructions and perhaps data that are read during execution of the instructions. Access to both RAM 530 and ROM 540 is typically faster than to secondary storage 550. The secondary storage 550 is typically comprised of one or more disk drives or tape drives and might be used for non-volatile storage of data or as an over-flow data storage device if RAM 530 is not large enough to hold all working data. Secondary storage 550 may be used to store programs that are loaded into RAM 530 when such programs are selected for execution.

The I/O devices 560 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 525 might be considered to be a component of the I/O devices 560 instead of or in addition to being a component of the network connectivity devices 520.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

It will be understood by one having ordinary skill in the art that construction of the described invention and other components is not limited to any specific material. Other exemplary embodiments of the invention disclosed herein may be formed from a wide variety of materials, unless described otherwise herein.

As used herein, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, arrangements described herein may take the form of a computer program product embodied in one or more computer-readable media having computer-readable program code embodied or embedded, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium.

What is claimed is:

1. A system for tightening a fastener, the system comprising:
a controller comprising:
a memory; and
a processor coupled to the memory, the processor configured to:
transmit a first command to a tool, the first command comprising a torque value;
receive a signal indicating the fastener has reached a predetermined angle of rotation after the fastener is tightened to the torque value; and
in response to receiving the signal, transmit a second command to the tool comprising an instruction to cease tightening;
the tool comprising:
a rotary encoder configured to determine the rotational angle of the fastener and output the signal at the predetermined angle of rotation;
a controller interface to receive the first command and the second command from the controller; and
a tool head configured to tighten the fastener based, at least in part, upon the first command and the second command.

2. The tool of claim 1, wherein the predetermined angle of rotation aligns a slot of the fastener with a pin hole.

3. The tool of claim 2, wherein the fastener is a castellated nut.

4. The tool of claim 3, wherein the castellated nut is hexagonal in shape and the predetermined angle of rotation is a multiple of sixty degrees.

5. The tool of claim 1, wherein the tool is a nutrunner.

6. A system for tightening a fastener, the system comprising:
a controller comprising:
a memory; and
a processor coupled to the memory, the processor configured to:
transmit a first command to a tool, the first command comprising a torque value;
receive a rotational angle of the fastener after the fastener is tightened to the torque value;
determine an additional rotation based, at least in part, on the rotational angle; and
transmit a second command to the tool comprising the additional rotation;
the tool comprising:
a rotary encoder configured to determine the rotational angle of the fastener;
a controller interface to receive the first command and the second command from the controller; and
a tool head configured to tighten the fastener based, at least in part, upon the first command and the second command.

7. The system of claim 6, wherein the memory comprises a plurality of programs associated with a plurality of fasteners.

8. The system of claim 6, wherein the second position aligns a slot on the fastener with a pin hole.

9. The system of claim 8, wherein the fastener is a castellated nut.

10. The system of claim 9, wherein the castellated nut is hexagonal in shape and the second position is a multiple of sixty degrees.

11. The system of claim 6, wherein the processor configured to determine the additional rotation comprises the processor configured to:
subtract the rotational angle of the fastener from a multiple of a predetermined fraction of 360 degrees.

12. The system of claim 6, wherein the tool is a nutrunner.

13. A method for tightening a fastener, the method comprising:
transmitting, from a controller to a tool, a first command comprising a torque value;
receiving, by the controller, a rotational angle of the fastener after the fastener is tightened to the torque value;
determining, by the controller, an additional rotation based, at least in part, on the rotational angle; and
transmitting, from the controller to the tool, a second command comprising the additional rotation.

14. The method of claim 13 further comprising retrieving a program from a memory of the controller comprising the torque value.

15. The method of claim 13, wherein the second position aligns a slot on the fastener with a pin hole.

16. The method of claim 15, wherein the fastener is a castellated nut.

17. The method of claim 16, wherein the castellated nut is hexagonal in shape and the second position is a multiple of sixty degrees.

18. The method of claim 13, wherein determining the additional rotation comprises:
subtracting the rotational angle of the fastener from a multiple of a predetermined fraction of 360 degrees.

19. The method of claim 13, wherein the tool is a nutrunner.
